(19) United States
(12) Patent Application Publication
(10) Pub. No.: US 2011/0262044 A1
(43) Pub. Date: Oct. 27, 2011

(54) ENERGY SAVING METHOD FOR ELECTRONIC DEVICE

(75) Inventor: PO-HSIUNG WANG, TAIPEI COUNTY (TW)

(73) Assignee: ELITEGROUP COMPUTER SYSTEMS CO., LTD., TAIPEI (TW)

(21) Appl. No.: 12/958,553

(22) Filed: Dec. 2, 2010

Related U.S. Application Data
(60) Provisional application No. 61/326,337, filed on Apr. 21, 2010.

(51) Int. Cl. G06K 9/46; G06K 9/40; G06K 9/68; G06F 1/32

(52) U.S. Cl. 382/218; 713/320; 382/275; 382/190

(57) ABSTRACT

An energy saving method for electronic devices is revealed. At least one reference image and a plurality of temporal images are set up by capturing a temporal scene in front of an electronic device. Compare the reference image with each temporal image to check if the user is in front of the electronic device. If the user is not in front of the electronic device, the electronic device is driven to enter the energy saving mode for saving power consumption of the electronic device.

### BACKGROUND OF THE INVENTION

1. Fields of the invention

The present invention relates to a method for controlling use of electronic devices, especially to an energy saving method for electronic devices.

2. Descriptions of Related Art

Today, increasing global warming and energy shortage problems have a huge impact on our lives. Thus energy saving and environmental protection have become important issues received the most attention worldwide. Most countries of the world focus on education and research of carbon emission reduction and green energy development. The global warming will lead to disasters such as strong storm and widespread drought, melting of snow and ice, rising sea levels, climate changes. These disasters cause significant changes of the earth and even cause human extinction. For reducing negative effects of global warming, people try hard to cope with these impacts and the changing climate. Most important of all is to promote energy conservation, reduce the consumption of resources, improve energy efficiency and develop renewable energy sources for reducing heat and carbon dioxide produced. This will reduce the warming effect.

Now in an era of advanced technology, power-saving is a critical issue and key theme in the design of most electronic products. While purchasing electronic products, power saving is one of the most important factors that consumers will consider. Every family is equipped with various electronics, especially portable electronic products. These electronic products provide more and more functions to satisfy customers' needs and requirements and make our lives more convenient. However, along with the increasing of functions, the power consumed by the electronic device is getting more and more. During the period between booting and standby state, the electronic devices available on the market now have no power saving mechanisms. When a user works with an electronic device and leaves for a while, or stop using the electronic device to do something else, the power consumption during the period is quite high after months and years of work.

For example, the notebooks or desktops available on the market now generally only provide an energy saving function when the apparatus is in the standby state. There is no other power saving mechanism before entering the standby mode and activating the energy saving function. Thus power is wasted during the period that the user left the electronic device temporarily without using the apparatus. This is a critical issue to reduce power consumption of the electronic devices significantly for energy saving and slowing global warming.

Thus there is a need to provide an energy saving method for electronic devices not only overcomes above shortcomings of prior arts but also saves energy.

### SUMMARY OF THE INVENTION

Therefore it is a primary object of the present invention to provide an energy saving method for electronic devices that checks whether users are in front of electronics and drives the electronics entering an energy saving mode when users are not available. Thus energy conservation is achieved.

In order to achieve the above object, the energy saving method for electronic devices of the present invention includes a plurality of steps. Firstly, capture a temporal scene and generate at least one image. Then check if a user is in front of an electronic device according to the image. If the user is not in front of the electronic device, the electronic device is driven to enter an energy saving mode so as to achieve energy conservation.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flow chart of an embodiment of an energy saving method for electronic devices according to the present invention;

FIG. 2 is a flow chart of another embodiment of an energy saving method for electronic devices according to the present invention;

FIG. 3 is a schematic drawing showing difference between the background edge information of two adjacent images according to the present invention;

FIG. 4 is a schematic drawing showing difference between the foreground edge information of two neighboring images according to the present invention.

### DETAILED DESCRIPTION OF THE PREFERRED EMBODIMENT

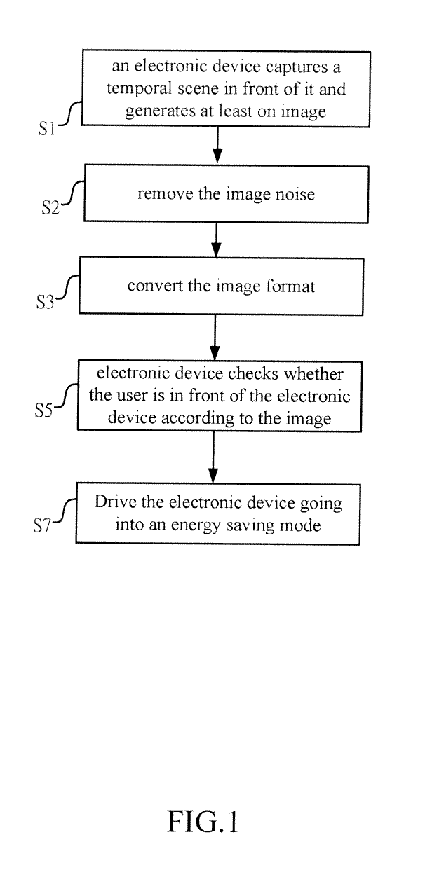

Refer to FIG. 1, a flow chart of an embodiment of an energy saving method for electronic devices according to the present invention is revealed. This energy saving method is applied to various electronic devices such as personal computers, notebooks, or other portable electronics. Refer to the step S1 in the FIG. 1, an electronic device captures a temporal scene in front of it and generates at least on image when a user operate the electronic device. The image can be captured by a webcam arranged at the electronic device that takes the temporal scene in front of the electronic device. Next as shown in the step S5, the electronic device checks whether the user is in front of the electronic device according to the image. If the user is not there, this means the user is not operating the electronic device and run the next step S7. Drive the electronic device going into an energy saving mode. For example, hardware not in use such as backlight is turned off, adjust screen brightness to make the screen darker, or minimize all programs executed by the electronic device so as to save power consumption. The energy saving mode is only an embodiment of the present invention, not intend to limit the scope of the present invention, the modes can have different settings according to users' needs.

The electronic device checks whether the user is in front of the electronic device according to the image. An embodiment of the checking way is by face recognition. Individual face features in the image such as eyes, nose, mouth etc have been detected. When the image detected includes the above face features, this represents that the user is still in front of the electronic device for operating the electronic device. On the contrary, of there is no face feature detected in the image, this means the user is not available in front of the electronic device. Then the electronic device enters to the energy saving mode. Face Recognition is known to the skilled person and is not described in details.

Refer to FIG. 1, each sensor of the Webcam produced may have difference in the quality. The photo sensors with poor quality are easily to have noise problem. Or various background noises are generated from the surrounding environments. After generating the image, take the step S2, remove the image noise by a plurality of noise filtering algorithm so as to decrease the error detection. And the accuracy of checking if the user is in front of the electronic device is further increased. In the present invention, low-pass-filter is used to remove high-frequency noises. Or use the median filter to remove noises. The above ways are only embodiments of the present invention and are not intended to limit the scope of the present invention.

Back to FIG. 1, run the step S5, check if the user is in front of the electronic device according to the image. Firstly, take the step S3, convert the image format. This step is a color space conversion of the image from the original RGB format to YCbCr format. Generally, the images captured by the Webcam are in RGB format while YCbCr represents color as brightness and two color difference signals, Y which is luminance, Cb and Cr are the blue-difference and red-difference chroma components. In the following image recognition, blue-difference (Cb) and red-difference (Cr) chroma components are used directly. Using YCbCr coding techniques are less affected by the elements in the environment such as brightness so as to avoid distortion or error-detection due to the influence of the brightness. Thus the accuracy of the image recognition is improved.

The energy-saving method of the present invention uses a micro-processing unit in the electronic device to drive the Webcam capturing a temporal scene in front of the electronic device and getting the image. Moreover, the micro-processing unit is in charge of all above processes for checking if the user is in front of the electronic device. Thus when the user is not in front of the electronic device and the electronic device is not in use, the electronic device shifts to the energy saving mode automatically for saving power.

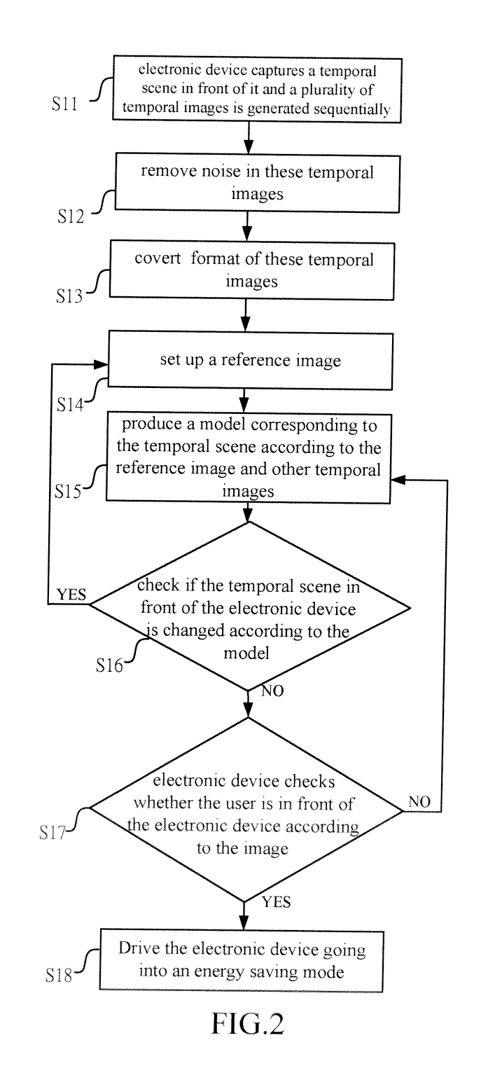

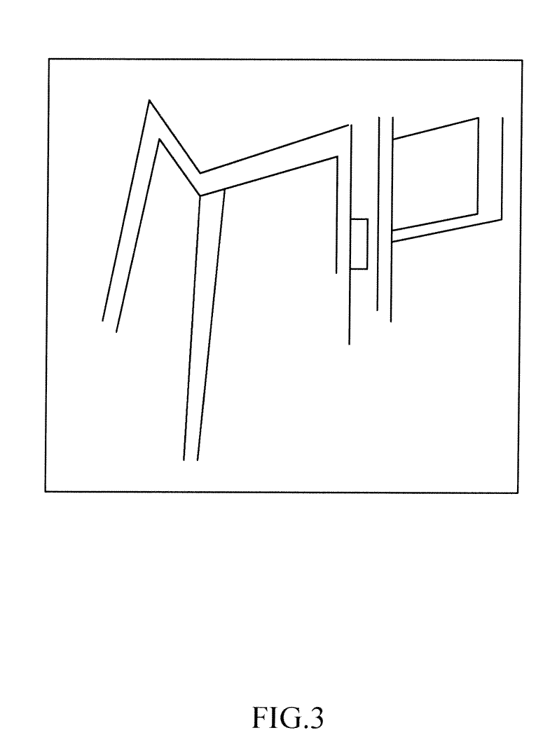

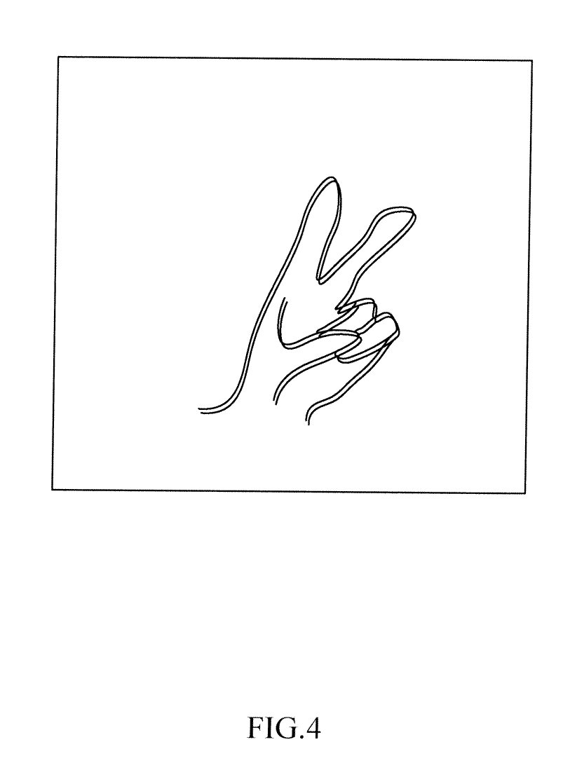

Refer to FIG. 2, FIG. 3, and FIG. 4, a flow chart of another embodiment, a schematic drawing showing difference between the background edge information of two adjacent images, and a schematic drawing showing difference between the foreground edge information of two neighboring images are disclosed. As shown in the step S11 of FIG. 2, an electronic device captures a temporal scene in front of it by a Webcam and a plurality of temporal images is generated sequentially. Next for following checking if the use is in front of the electronic device more accurately, take the step S12 and the step S13, remove noise in these temporal images and covert color format of these temporal images. These two steps are the same with the step S2 and the step S3 in FIG. 1.

Then refer to the step S14, set up a reference image. In this step, the first temporal image of the plurality of the temporal images captured by the Webcam is used as a reference image. The first temporal image shows an initial state of the temporal scene in front of the electronic device captured by the Webcam. Later as shown in the step S15, produce a model corresponding to the temporal scene according to the reference image and other temporal images. The present invention generates the model by difference between the edge information of the images. The difference between the edge information of the images is an absolute value obtained by algorithm and deduction of the edge information of two adjacent images. Once the two images are totally the same, the difference between the edge information of the two images is zero. If the difference between the edge information of the two images is larger, the two images are quite different from each other. Thus the difference between the edge information of the two images is getting obvious when the temporal scene in front of the electronic device changes. This represents that the electronic device has been moved and the temporal scene in front of the electronic device has been changed. Therefore whether the electronic device is moved and the scene is changed is checked by means of a model of the temporal scene (the difference between the edge information of the images).

One embodiment of the above way calculating the difference between the edge information of the two images is by deducting the reference image from other temporal image and taking the absolute value so as to get the difference between the edge information. However, the speed of the Webcam to capture the temporal scene and to generate temporal images varies. When the speed of capturing the temporal scene is slower, compare all the temporal images in turn with the reference image to get the difference between the edge information. Due to the slow capturing speed, the difference between the edge information is quite obvious if the temporal scene has changed. While with the fast capturing speed, the difference between the edge information of two adjacent images is not clear. Thus the temporal images are sampled at an interval to compare with the reference image for obtaining the difference between the edge information. Therefore, the difference during the shift of the temporal scene is highlighted.

Refer to the step S16, check if the temporal scene in front of the electronic device is changed according to the model. That means whether the temporal scene in front of the electronic device is changed is checked according to the difference between the edge information. Once the electronic device has been moved by the user, the temporal scene in front of the electronic device is changed. As shown in FIG. 3, it is clear that the difference between the edge information of the temporal image and the reference image. This represents that the electronic device has been moved and the temporal scene in front of the electronic device has been changed. The present invention further has a first threshold used for checking if the temporal scene in front of the electronic device is changed and further checking if the step S14 is run again, to build a reference image again or not. The first threshold is a default value or is able to be set by the users freely. When the difference between the edge information is over the set first threshold, turn back to the step S14, set up a reference image again. And the temporal scene in front of the electronic device is captured again and is used as a new reference image. If the difference between the edge information is not over the set first threshold, refer to the step S17, check if the user is available in front of the electronic device. As shown in FIG. 4, the difference between the edge information of the temporal image and the reference image is not obvious. This means the electronic device is not moved by the user and the temporal scene in front of the electronic device is not changed. It may be that only the user moved.

In the step S17, check if the user is available in front of the electronic device according to the model. That means compare the difference between the edge information with a second threshold. The second threshold is different from the first threshold. In a preferred embodiment, the second threshold is smaller than the first threshold. When the difference between the edge information is smaller than the second threshold, this represents that the user is moved yet the movement is limited and the user is still in front of the electronic device. If the difference between the edge information is larger than the second threshold, this represents that the user is moved and moved a lot. Thus it is checked that the user is not in front of the electronic device and not is use of the electronic device. Thus take the step S18, drive the electronic device entering the energy saving mode. Therefore, energy reduction and power saving are achieved by the present invention that checks whether the user is in front of the electronic device. The second threshold is a default value or is able to set freely by users.

Moreover, the movement of pets or other objects may cause the difference between the edge information larger than the second threshold. Thus the present invention further includes a step of checking if a difference image formed by deduction of one image from the other image includes face features or not when the difference between the edge information is larger than the second threshold so as to confirm that the user do leave the electronic device, without using the electronic device. Therefore, the electronic device is driven to enter the energy saving mode.

The present invention detects whether the temporal scene in front of the electronic device changes according to the plurality of temporal images. If the temporal scene is not changed, then check if the user is in front of the electronic device according to those temporal images. Thus the electronic device automatically enters the energy saving mode for saving power and reducing energy consumption when the user is not in front of the electronic device. Furthermore, in the other embodiment of the present invention, there is no need to build a reference image. The difference between the edge information is directly calculated according to the two temporal images and further set up the model of the temporal scene. There is also no need to compare other temporal images with the reference image. Thus the step S14 can be omitted and the step S15 is also not required to generate the model by comparison with the reference image.

In addition, in the step S17 of checking if the user is available in front of the electronic device, there is no need to compare the difference between the edge information with the second threshold. The present invention can use face recognition to check if the difference image formed by deduction of one image from the other image includes face features or not. For example, whether the difference image in FIG. 4 includes face features is checked by face recognition. If the difference image doesn't include the face feature, this means the user is already left the electronic device, not n front of the device. Now the electronic device enters the energy saving mode to reduce power consumption. Thus whether the user is in front of the electronic device is confirmed by face recognition. And there is no need to make a comparison of the difference between the edge information and the second threshold.

In summary, an energy saving method for electronic devices according to the present invention includes following steps. Capture a temporal scene in front of an electronic device and generate at least one image. Then check if the user is in front of the electronic device according to the image. Once the user is not available, the electronic device is driven to enter the energy saving mode. Thus energy conservation is achieved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An energy saving method for electronic devices comprising the steps of:
capturing a temporal scene in front of an electronic device to generate at least one image;
checking an user not available in front of the electronic device according to the image; and
driving the electronic device entering an energy saving mode.

2. The method as claimed in claim 1, wherein after the step of capturing a temporal scene in front of an electronic device to generate at least one image, the method further includes a step of:
removing noise from the image.

3. The method as claimed in claim 1, wherein the method further includes a step of:
converting format of the image.

4. The method as claimed in claim 1, wherein in the step of capturing a temporal scene in front of an electronic device, a plurality of temporal images is generated in turn and the method further includes a step of checking if the temporal scene in front of the electronic device is changed according to the plurality of temporal images; if the temporal scene is not changed, checking if the user is in front of the electronic device according to the plurality of temporal images.

5. The method as claimed in claim 4, wherein the method further includes the steps of:
building a model of the temporal scene in front of the electronic device according to the plurality of temporal images;
checking if the temporal scene in front of the electronic device is changed according to the model; if the temporal scene is changed, build the model again; and
checking if the user is in front of the electronic device according to the model.

6. The method as claimed in claim 5, wherein the method further includes a step of:
capturing an initial state of the temporal scene in front of the electronic device and set up a reference image so as to build the model by comparison between the reference image and the temporal images; if changing of the temporal scene in front of the electronic device is detected, build the reference image again.

7. The method as claimed in claim 5, wherein the method further includes the steps of:
comparing the temporal images to get difference between edge information of the temporal images so as to build the model; and
comparing the difference between edge information with a first threshold for checking if the temporal scene in front of the electronic device is changed.

8. The method as claimed in claim 7, wherein the method further includes a step of:
comparing the difference between edge information with a second threshold for checking if the user is in front of the electronic device.

9. The method as claimed in claim 5, wherein in the step of checking if the user is in front of the electronic device according to the model, at least one face feature in the model is detected so as to check if the user is in front of the electronic device.

10. The method as claimed in claim 1, wherein in the step of checking an user not available in front of the electronic device according to the image, at least one face feature in the image is detected so as to check whether the user is in front of the electronic device.
